(19) United States
(12) Patent Application Publication
(10) Pub. No.: US 2026/0337989 A1
(43) Pub. Date: Oct. 29, 2026

(54) HARDWOOD FLOOR REMOVAL TOOL

(71) Applicant: Benjamin Weinreich, Sykesville, MD (US)

(72) Inventor: Benjamin Weinreich, Sykesville, MD (US)

(21) Appl. No.: 19/531,751

(22) Filed: Feb. 6, 2026

Related U.S. Application Data
(60) Provisional application No. 63/754,619, filed on Feb. 6, 2025.

(51) Int. Cl. E04G 23/08; B66F 15/00

(52) U.S. Cl. CPC E04G 23/08; B66F 15/00; E04G 2023/085

(57) ABSTRACT

An improved hardwood floor removal tool comprising a squared handle with an L-shaped heel attached distally on one side that abuts the top of a hardwood plank to be removed for leverage, and an L-shaped wedge attached distally on the other side that fits under the same hardwood plank. The L-shaped wedge is forced between the subfloor and HF plank using a dead-blow hammer, the heel is lowered into contact with the HF plank to establish a fulcrum at the top back corner of that plank, and the handle is leveraged to torque the HF plank upward at the wedge about the fulcrum. The HF plank is removed without damage and leaving just a slight curve to the nails, and the entire hardwood floor can be easily removed in reverse order of install.

### PRIORITY TO RELATED APPLICATIONS

The present application derives priority from U.S. Provisional Patent Application No. 63/754,619 filed Feb. 6, 2025.

### BACKGROUND OF THE INVENTION

### Field of the Invention

The present invention relates generally to demolition tools and more particularly, to tools for removing hardwood flooring.

### Description of the Background

Traditional hardwood floors are made from a variety of wood planks placed in side-by-side relation to each other with the side edges engaged by tongue-and-groove interlocks. In order to secure the floorboard to the subfloor, nails are driven at an angle through a portion of the tongue of the plank and into the subfloor below. Solid hardwood flooring is all wood whereas engineered hardwood flooring is a veneer of real wood glued to several layers of wood underneath, like plywood. Hardwood flooring comes in a variety of widths and thicknesses. The width of the planks can affect the look of the room, while the thickness affects the durability and stability of the floor.
Typical Widths: 2¼″-5″
Typical Thickness: ¾ in (19 mm) or ⅝ in (15 mm)
Typical length: 4′

Because of the combination of tongue-and-groove interlocks and nails driven at an angle into the subfloor below, hardwood floors are very sturdy and very difficult to remove. Thus, the process of removing hardwood flooring. is labor intensive, slow, and will result in damage to the floor sheathing by lacking an optimal way to defeat the toe-nailed planks.

There are other plank removal tools. For example, United States Patent Application 20110036205 to Marc Pafumi et al. (EZY Lifter Pty Ltd.) discloses a board removal tool an elongate handle leading to a unitary tool head having an L-shaped heel on one side that abuts the top of a panel that creates a fulcrum for leverage, and an L-shaped wedge on the other side that fits under the panel.

U.S. Pat. No. 8,789,810 to Weinreich discloses a deck board pulling tool 2 with a handle 10 with a head 20 with a proximate heel and offset head that hooks around the outside edge of each deck board to be removed. The user levers (pulls) the tool 2 toward himself. The next adjacent deck board serves as a fulcrum, and the inwardly-hooked configuration of demolition head 20 pulls the outside of the deck board directly up.

U.S. Pat. No. 8,585,016 to Wooley et al. (Stanley) shows a demolition tool with grasping jaws 107 that may be utilized to grasp, manipulate, and/or otherwise demolish building materials such as, for example, lumber.

U.S. Pat. No. 2,896,910 issued to Cooper et al. shows a wrecking bar with a U-shaped hook 6 formed at one end thereof and with the parallel side or arm portions 7 and 8 of the hook projecting laterally at one side of the bar.

The foregoing references illustrate a basic prybar structure with elongate handle leading to a unitary tool head having a projecting wedge on one side that fits under the panel, and a projecting heel on the other side that abuts the top of the next adjacent panel to create a fulcrum for leverage. They are designed to pry large face-fastened planks off a skeletal wood frame. None are adapted for removing tongue and groove planks from a subfloor sheathing system. To accomplish the latter it is necessary to: 1) force a wedge between the subfloor and HF plank using a dead-blow hammer; 2) while touching only the plank to be removed, establish a fulcrum at the top back corner of that plank; and 3) lever the plank upward at the wedge about the fulcrum. This way, the entire hardwood floor can be removed in reverse order of install, without damage to the HF planks and leaving just a slight curve to the nails.

What is needed is a more convenient means for removing hardwood flooring that accomplishes the foregone without breaking floor planks or leaving potentially hazardous nails on the job site and offering minimal floor sheathing damage because the toenails are pulled almost straight out rather than being forced out by shear loading with standard methods like prybars.

### SUMMARY OF THE INVENTION

Accordingly, it is an object of the present invention to provide an improved hardwood flooring removal tool that can be used by the operator from a standing position.

It is also an object of the present invention to provide an improved hardwood floor tool capable of removing successive planks of a residual hardwood floor, and that is repeatable for each residual plank along the entire floor in reverse order of install.

These and other features and benefits are achieved with an improved hardwood floor removal tool comprising a squared handle with an L-shaped heel attached distally on one side that abuts the top of a hardwood plank to be removed for leverage, and an L-shaped wedge attached distally on the other side that fits under the same hardwood plank. The HFR tool is designed for a 2-¼″ wide flooring plank to remove it almost instantly. In use, the L-shaped wedge is forced between the subfloor and HF plank using a dead-blow hammer, and (touching only the plank to be removed) the heel is lowered into contact with the HF plank to establish a fulcrum at the top back corner of that plank. The handle is leveraged to torque the HF plank upward at the wedge about the fulcrum. After the initial hammer strike to set the HFR tool, twisting the handle defeats all toe-nails in sequence, beginning with those in the immediate vicinity and running outward, ultimately causing the board to fully dislodge in seconds. The HF plank is removed without damage and leaving just a slight curve to the nails, and the entire hardwood floor can be easily removed in reverse order of install.

For a more complete understanding of the invention, its objects and advantages, refer to the remaining specification and to the accompanying drawings.

### BRIEF DESCRIPTION OF THE DRAWINGS

Other objects, features, and advantages of the present invention will become more apparent from the following detailed description of the preferred embodiment and certain modifications thereof, in which:

FIG. 1 is a perspective view of the improved hardwood floor removal tool according to the present invention.

FIG. 2 is a side view of the improved hardwood floor removal tool according to the present invention, in use.

FIG. 3 is a cross-section illustrating L-shaped heel 20 made to be removable and/or replaceable or reversable.

### DETAILED DESCRIPTION OF THE PREFERRED EMBODIMENTS

As seen in FIG. 1, the improved hardwood floor removal tool 2 according to the present invention comprises a fixed-length handle 10 of 3-5′ length with square 1.5″ cross-section at one end. At the other end of handle 10, a gripping section preferably comprising a rubberized hand grip allows the operator to comfortably grip handle 10 using one or both hands, and from a standing position, to position the distal end of handle 10. Two discrete tool sections are separately attached to the handle 10 on opposing faces of the squared distal end, including an L-shaped heel 20 configured to abut the top of a hardwood plank to be removed for leverage, and an L-shaped wedge 30 attached distally on the other side that fits under the same hardwood plank. The L-shaped heel 20 may be formed from a bent angle-iron, e.g., a piece of structural steel bent in a shallow L-shape. The L-shaped wedge 30 may be similarly formed and bent in a deeper L-shape. The L-shaped heel 20 preferably is formed with a beveled inside edge interrupted by plurality of distal toes 22 to disperse force.

The L-shaped heel 20 is attached to one face of handle 10 with distal toes 22 projecting either outward and away from handle 10, or inward and beneath handle 10. Conversely, the L-shaped wedge 30 is attached to the opposing face of handle 10 with the wedge section projecting inward and beneath handle 10, spaced therefrom by a jaw height opening J. Preferably, the L-shaped heel 20 is attached to the L-shaped wedge 30 by a plurality of through-bolts passing through the handle 10 for maximum structural robustness. This ensures that the tool 2 is able to withstand wedging forces applied downward against L-shaped wedge 30, which are dispersed through multiple through-bolts affixed to the heel 20. Optimal tool 2 dimensions are as follows.

To function optimally with ⅝″ or ¾″ thick flooring, the jaw height opening J should be sized to accommodate a ¾″ thick HF plank, leaving 1/64″- 1/16″ clearance. Thus, jaw height opening J is optimally between 41/64″ and 13/16″. So long as the jaw height J is close tolerance to the ¾″ plank-it will work for ⅝″ thickness as well.

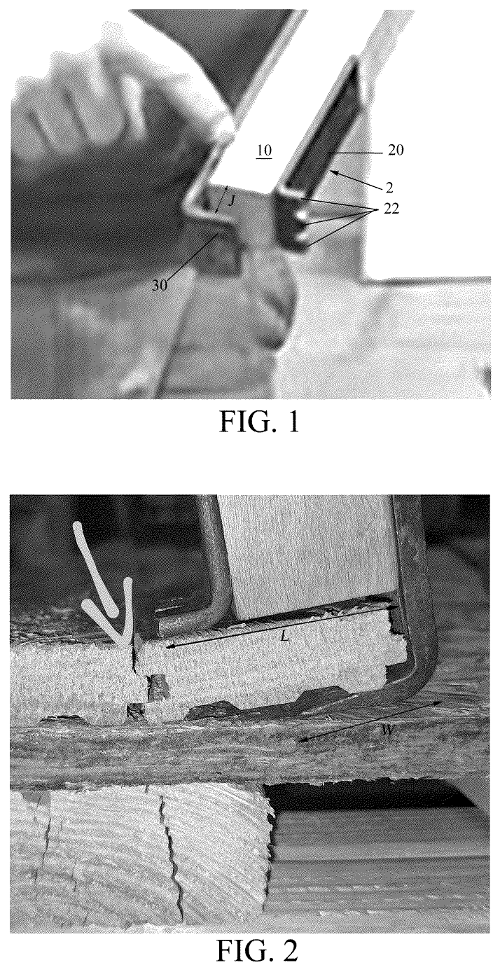

FIG. 2 is a side view of the improved hardwood floor removal tool according to the present invention, in use. The throat length L must be no longer than the HF plank is wide, or the fulcrum point becomes non-optimal. Thus, for example, most tongue and groove HF flooring planks are 2.25″ wide. To establish the fulcrum on the plank to be removed a throat length L any wider than the plank itself will change the fulcrum point and the tool 2 will not work as effectively. For an HF planks 2.25″ wide, a throat length L of 2.0″ is optimal and within a range of from 1.8″ to 2.25″. This will also function well on planks up to 4″ wide. However, for excessively wide planks the anchoring toe-nails are less in-line with the arc the tool 2 applies, and so effectiveness diminishes for HF planks beyond 4″ wide.

The L-shaped wedge 30 extends beneath handle 10 by a length W and cannot be too short or too thick. If the bevel is abrupt then hammering the wedge 30 under the plank will apply excess shear load to the toe-nails, as opposed to a thinner more gradual bevel which will slide in easier. The optimal dimensions for the wedge 30 are approximately 1″ long (length W) by 3/16″ thick by 1.4″ wide, which fits well on a 1.5″ wide handle. These allow the wedge 30 be set beyond the toe-nail penetration.

The foregoing dimensions create a fulcrum as shown by the arrow (FIG. 2) and ensures that the tool 2 only touches the HF plank in two spots during the actual twist portion.

Both L-shaped heel 20 and L-shaped wedge 30 may be formed of ¼″ thick 4140 or 4340 alloy steel, or grade 80 impact resistant steel due to constant hammer strikes.

In use, as seen in FIG. 2, the L-shaped wedge 30 is forced between the subfloor and HF plank using a dead-blow hammer which defeats all to-nails in the immediate vicinity. Handle 10 is the leveraged back until heel 20 comes to bear at the top back corner of that same plank. The handle is leveraged to torque the HF plank upward at the wedge about the fulcrum. By twisting the tool 2, the remainder of any plank toe nails are defeated in sequence causing the HF board to fully dislodge in seconds, touching only the plank to be removed. The HF plank is removed without damage and leaving just a slight curve to the nails, and the entire hardwood floor can be easily removed in reverse order of install. Importantly, maintaining the fulcrum at the arrow (FIG. 2) gives two advantages. First the arc from pivoting there produces an optimal defeat angle to the toe-nails, by pulling them almost straight out. Second, by virtue of the tool being able to continuously apply rotational force to the plank down the plank's entire length with that same optimal angle, the plank can be removed with one action much like unzipping a zipper. These two functions synergistically combine to allow entire HF boards to pop out in seconds. Moreover, the lever-type removal tool allows the user to remain upright during operation and to remove HF planks from a standing position during demolition, saves the operator the strain and time of bending over to perform the removal operation, greatly lessening the possibility of physical strain or injury to the user.

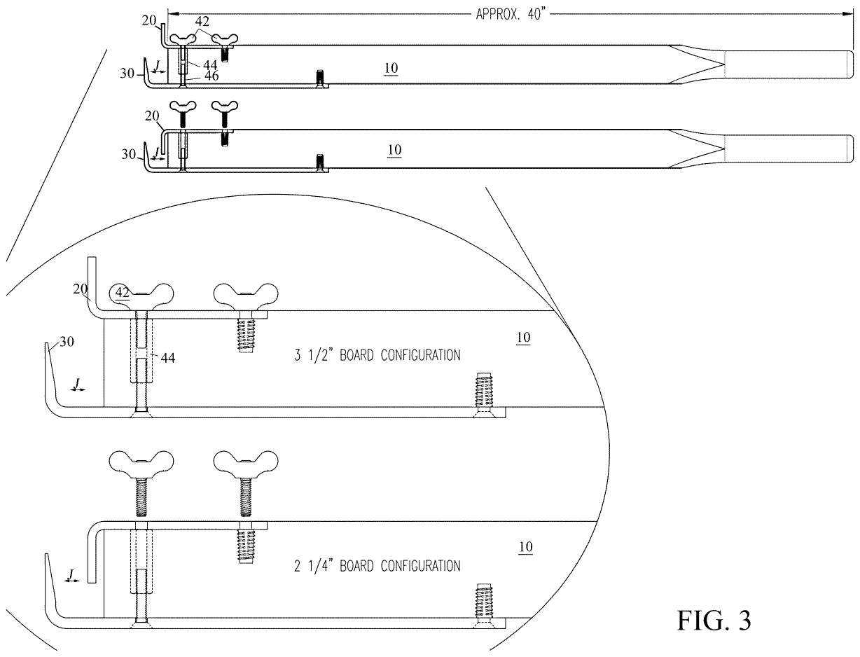

In an embodiment, the L-shaped heel 20 is removable and replaceable or reversable to adjust to function with HF planks that are 2.25″ wide or 4″ wide. FIG. 3 illustrates a cross-section of a reversable L-shaped heel 20. In this embodiment, the L-shaped heel 20 is attached to one face of handle 10 with two thumbscrews 42 for ease of removal/reversal. One thumbscrew 42 is threaded directly through heel 20 into handle 10, but the other is screwed into a sleeve 44 that is threaded at both ends, sleeve 44 also serving as an anchor for wedge 30 which is fixedly screwed to handle 10 in two spaced locations as shown. Initially, the L-shaped heel 20 is attached to one face of handle 10 with distal toes 22 projecting outward and away from handle 10 (top) to accommodate wider 4″ HF planks. However, thumbscrews 42 can be removed, heel 20 reversed to project inward and beneath handle 10, and thumbscrews 42 reattached to alter the fulcrum for narrower 2.25″ HF planks. As an alternative, different size (replaceable) heels 20 and/or wedges 30 may be included as a set to accommodate different widths and thickness HF planks. In all the foregoing cases the particular construction shown in FIG. 3 ensures that the tool 2 is able to withstand wedging forces applied downward against L-shaped wedge 30, which are dispersed through the handle 10 to the heel 20.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A tool for removing HF planks from a subfloor, comprising:
an extended handle having a square cross-section at one end;
an L-shaped heel formed from an angle-iron and attached to one face of said handle at said squared end and projecting away from said face;
an L-shaped wedge formed from an angle-iron and attached to an opposite face of said handle at said squared end and projecting inward a distance W beneath said handle, spaced therefrom by a distance J.
